(19) United States
(12) Patent Application Publication
(10) Pub. No.: US 2017/0355575 A1
(43) Pub. Date: Dec. 14, 2017

(54) CARGO CONTAINER CRANE

(71) Applicants: Zhoumin Ni, New York, NY (US); Guangwei Wang, Fuzhou (CN)

(72) Inventors: Zhoumin Ni, New York, NY (US); Guangwei Wang, Fuzhou (CN)

(21) Appl. No.: 15/619,045

(22) Filed: Jun. 9, 2017

(30) Foreign Application Priority Data
Jun. 12, 2016 (CN) 201620562727

(51) Int. Cl. B66C 23/48; B66C 23/46; B66C 9/14; B66C 23/00; B66C 23/38

(52) U.S. Cl. CPC B66C 23/48; B66C 23/54; B66C 23/38; B66C 9/14; B66C 23/46

(57) ABSTRACT

A cargo container crane includes a body, having a bottom and top, the body including at least one drive wheel and a turning wheel at the bottom, and a horizontal cantilever at the top, the cantilever and the top of the body including a turning device, a drive motor that drives the at least one drive wheel, a lift motor, a lifting rope, a lifting rope drive device, wherein the lifting rope runs through the turning device, with one end of the lifting rope connected to a hook and the other end of the lifting rope connected to the lifting rope drive device, and a control handle, having a first button that causes forward and backward movement of the cargo container crane, and a second button that causes raising and lowering of the hook.

### FIELD OF THE INVENTION

This disclosure relates generally to cargo transport devices and, more particularly, to cranes for cargo containers.

### BACKGROUND

Cargo containers are often used at factories to hold raw materials, accessories or products, and those cargo containers are usually transported around using a conventional cargo dolly. The dolly, commonly known as “tiger cart,” is a hand truck used for transporting goods in a warehouse. A dolly typically comprises a frame, the frame bottom is connected with a nose and a frame support, an axle is mounted on the frame support, with the two ends of the axle connected with wheels. In use, the nose is inserted underneath stacked goods, then the top end of the frame is tilted downward, such that the nose moves upward and leaves the ground, so that the goods are supported by the frame. When the dolly is moved to a designated new position, the top end of the frame is pushed upward, such that the nose moves downward to touch the ground, and then the goods can be unloaded. The whole process of loading, transporting and unloading cargo containers with a conventional cargo dolly is relatively cumbersome and inefficient.

### SUMMARY

The present disclosure describes a cargo container crane, which solves the problems that make loading, transport and unloading of current cargo containers relatively cumbersome and inefficient.

One aspect of this disclosure involves a cargo container crane. The cargo container crane includes a body, having a bottom and top. The body includes at least one drive wheel and a turning wheel at the bottom, and a horizontal cantilever at the top. The cantilever and the top of the body include a turning device, a drive motor that drives the at least one drive wheel, a lift motor, a lifting rope, and a lifting rope drive device. The lifting rope runs through the turning device, with one end of the lifting rope connected to a hook and the other end of the lifting rope connected to the lifting rope drive device. The cargo container crane also has a control handle, having a first button that causes forward and backward movement of the cargo container crane, and a second button that causes raising and lowering of the hook.

Other aspects of the disclosure involve the lifting rope and the turning device respectively being a steel cable and a fixed pulley.

Still other aspects of the disclosure involve the lifting rope and the turning device respectively being a chain and a sprocket.

With still other aspects of the disclosure, there are two lifting ropes, and the cantilever and the top of the body are both provided with two turning devices.

With yet other aspects of the disclosure, the lifting rope drive device is a hydraulic cylinder, or the lifting rope drive device comprises a rewinding motor and a rewinding disc, and the rewinding motor drives the rewinding disc.

Additional aspects of the disclosure involve a gearbox disposed between the drive motor and the drive wheels, and the drive motor drives the drive wheels via the gearbox.

Still further aspects of the disclosure involve the output shaft of the gearbox and the drive wheels all being provided with sprockets thereon, and the sprockets are connected to each other via chains.

Yet other aspects of the disclosure involve two drive wheels and one or two turning wheels, with the drive wheels and the turning wheels positioned in a triangle or a square arrangement.

With yet other aspects of the disclosure, the turning wheels are universal casters.

Further aspects of the disclosure involve, the body comprising a base and a support rod vertically disposed on the base, the base is formed with cargo container grooves, and the cargo container grooves are positioned underneath the cantilever.

Finally, additional aspects of the disclosure involve, the support rod being provided with an equipment box, and the drive motor, the lift motor and the rewinding device are disposed inside the equipment box, the cantilever and the support rod are hollow and the cavity formed thereby is for the lifting rope to go through.

Implementations of the present disclosure operate such that the lifting rope is lowered down to hook onto a cargo container, and the cargo container is then transported to a designated position and is then released. The entire process is, thus, simple and efficient; the buttons on the control handle can control the forward and backward movements of the cargo container crane, and can also control lift-up and lower-down of the lifting rope, leading to a high degree of automation and low work intensity for operators, thereby overcoming the problems with conventional cargo dollys.

The foregoing and following outlines rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified form, a schematic view of the structure of the cargo container crane; and

FIG. 2 illustrates, in simplified form, a schematic view of the structure of FIG. 1 from another direction.

### DETAILED DESCRIPTION

Specific examples of our cargo container crane will now be described with reference to the accompanying drawings. It should be apparent that the described examples are only representative of a few, not all, of the embodiments that can be created based upon this disclosure. All other embodiments that can be created by those skilled in the art based on the examples herein are intended to be encompassed by the present disclosure.

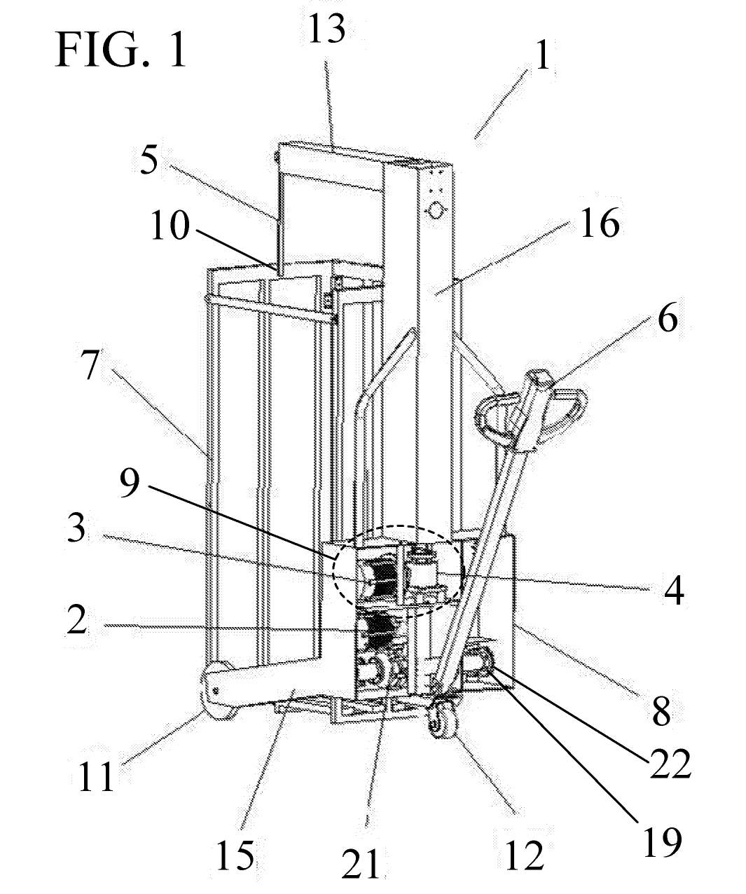

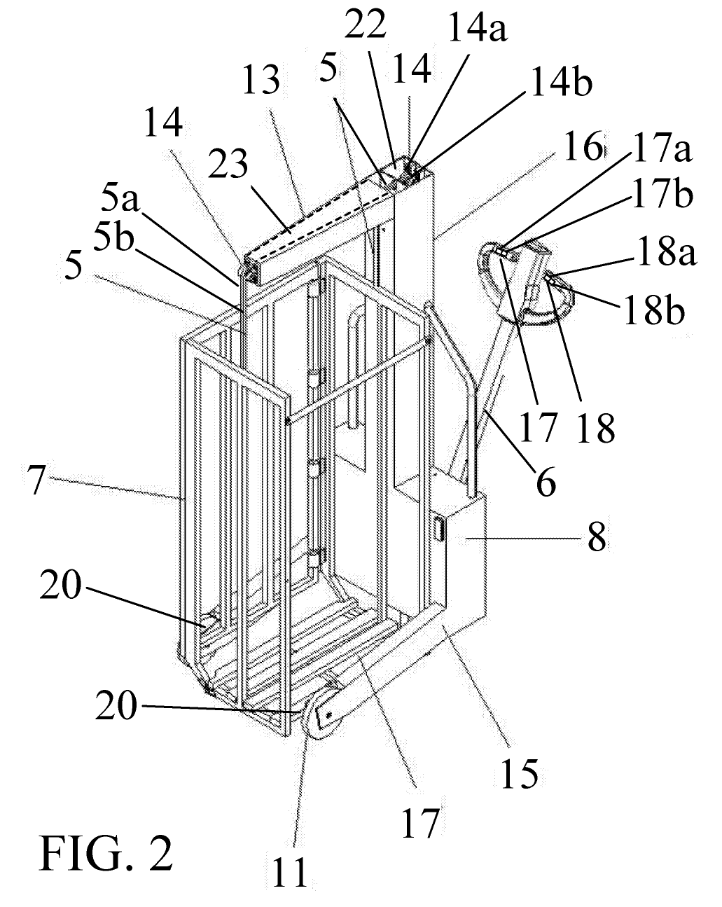

Referring to FIG. 1 and FIG. 2, a cargo container crane comprises a body 1, and the body 1 is provided with drive wheels 11 and at least one turning wheel 12 at the bottom and with a horizontal cantilever 13 at the top. The cantilever 13 and the top of the body 1 are both provided with a turning device 14. The body 1 is provided with a drive motor 2, a lift motor 3, a lifting rope 5 and a lifting rope drive device 9. The drive motor 2 drives the drive wheels 11, the lift motor 3 drives a rewinding device 4, the lifting rope 5 runs through the turning device 14, with one end of the lifting rope 5 connected to a hook 10, and the other end of the lifting rope 5 is connected to the lifting rope drive device 9. The body 1 is further provided with a control handle 6, and the control handle 6 is provided with a button 17 for forward and backward movement and a button 18 for raising and lowering the hook 10 on the lifting rope 5. During use, the lifting rope 5 is lowered down to hook on a cargo container 7, and the cargo container 7 is released when transported to a designated position. The entire process is simple and efficient. The buttons 17, 18 on the control handle 6 can respectively comprise a forward moving button 17a, a backward moving button 17b, a raising button 18a, and a lowering button 18b, which then can control the forward and backward movements of the cargo container crane, and can also control raising and lowering of the lifting rope 5, leading to a high degree of automation and reduce operator work intensity.

The lifting rope 5 and the turning device 14 are a steel wire cable (i.e., wire rope) and a fixed pulley or, alternatively, the lifting rope 5 and the turning device 14 are a chain and a sprocket. Steel cable and chain each have high strength and, thereby, each can be used as the lifting rope. Naturally, other structural forms for the lifting rope 5 may also be selected, as needed, so long as they have the strength to achieve the goal of raising and lowering the cargo container.

The cargo container crane ideally includes two lifting ropes 5, and the cantilever 13 and the top of the body 1 are both provided with two turning devices 14. When two lifting ropes 5 are provided, the cargo container 7 can be hooked at two places, such that the cargo container 7 will steadier during transport and swinging is reduced.

The lifting rope drive device 9 is either a hydraulic cylinder, or comprises a rewinding motor 3 and a rewinding disc 4, with the rewinding motor 3 driving the rewinding disc 4. The peripheral surface of the rewinding disc 4 is formed with rewinding grooves thereon. The rewinding device may also take other forms, as long as the goal of winding and unwinding the lifting rope 5 is achieved.

A gearbox 21 is connected between the drive motor 2 and the drive wheels 11, and the drive motor 2 rotationally drives the drive wheels 11, via the gearbox 21.

The output shaft of the gearbox 21 and the drive wheels 11 are provided with sprockets 19, 20 thereon, and the sprockets of the drive wheels 11 are connected to the sprocket(s) of the output shaft of the gearbox 21 via chains 22.

Ideally, there are two drive wheels 11 and one or two turning wheels 12, with the drive wheels 11 and the turning wheels 12 arranged to form a triangle or a right quadrilateral (preferably a square).

Ideally, the turning wheels 12 are universal casters.

The body 1 comprises a base 15 and a support rod 16 that is vertically disposed on the base 15. In addition, the base 15 is formed with cargo container grooves 17, and the cargo container grooves 17 are positioned underneath the cantilever 13 that facilitates raising and lowering of a cargo container 7 using the lifting rope 5.

Ideally, the support rod 16 is provided with an equipment box 8. The drive motor 2, the lift motor 3 and the rewinding device 4 are located inside the equipment box 8. The provision of the equipment box 8 protects the parts therein and makes for a neater appearance.

Preferably, the cantilever 13 and the support rod 16 are internally hollow 22, 23 and the cavity formed thereby is for the lifting rope 5 to pass through. By providing the cavity, the lifting rope runs internally, thereby making the appearance neater and the crane safer by preventing an operator's fingers from easily being caught in the lifting rope 5.

Having described and illustrated the principles of this application by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A cargo container crane, comprising:
a body, having a bottom and top, the body including
at least one drive wheel and a turning wheel at the bottom, and
a horizontal cantilever at the top, the cantilever and the top of the body including a turning device,
a drive motor that drives the at least one drive wheel,
a lift motor,
a lifting rope,
a lifting rope drive device, wherein the lifting rope runs through the turning device, with one end of the lifting rope connected to a hook and the other end of the lifting rope connected to the lifting rope drive device, and
a control handle, having a first button that causes forward and backward movement of the cargo container crane, and a second button that causes raising and lowering of the hook.

2. The cargo container crane of claim 1, wherein:
the lifting rope is a steel cable and the turning device is a pulley.

3. The cargo container crane of claim 2, wherein the lifting rope comprises at least two lifting ropes, and the cantilever and the top of the body both include two turning devices, one for each lifting rope.

4. The cargo container crane of claim 1, wherein:
the lifting rope is a chain and the turning device is a sprocket.

5. The cargo container crane of claim 1, wherein the lifting rope drive device is a hydraulic cylinder.

6. The cargo container crane of claim 1, wherein the lifting rope drive device comprises a rewinding disc and a rewinding motor that drives the rewinding disc.

7. The cargo container crane of claim 1, further comprising:
a gearbox between the drive motor and the drive wheels, such that the drive motor drives the drive wheels, via the gearbox, to cause the drive wheels to rotate.

8. The cargo container crane of claim 7, wherein:
the gearbox includes an output shaft having a sprocket thereon, and wherein at least one drive wheel has a sprocket thereon, and wherein the sprocket of the at least one drive wheel is connected to the sprocket of the output shaft via a chain.

9. The cargo container crane of claim 8, wherein:
the at least one drive wheel comprises two drive wheels, and
wherein the turning wheel and two drive wheels are positioned to collectively form a triangle.

10. The cargo container crane of claim 8, wherein:
the at least one drive wheel comprises two drive wheels,
the turning wheel comprises two turning wheels, and
wherein the two drive wheels and the two turning wheels are positioned to collectively form a right quadrilateral shape.

11. The cargo container crane of claim 10, wherein the turning wheels are universal casters.

12. The cargo container crane of claim 1, wherein the turning wheel is a universal caster.

13. The cargo container crane of claim 1, wherein the body further comprises:
a base, and
a support rod vertically disposed on the base,
wherein the base includes cargo container grooves positioned underneath the cantilever.

14. The cargo container crane of claim 13, wherein:
the support rod includes an equipment box,
the drive motor, the lift motor and the rewinding device are located inside the equipment box,
the cantilever and the support rod each include a hollow cavity, and
the lifting rope passes through the hollow cavities.
